(19) United States
(12) Patent Application Publication
(10) Pub. No.: US 2015/0138910 A1
(43) Pub. Date: May 21, 2015

(54) DENTAL VACUUM MIXER

(71) Applicant: Jong-dae Cha, Daegu (KR)

(72) Inventors: Jong-dae CHA, Daegu (KR); Dong Kuk Kim, Daegu (KR); Seung Jae Lee, Daegu (KR); Sung Jin Park, Daegu (KR)

(73) Assignee: Jong-dae Cha, Daegu (KR)

(21) Appl. No.: 14/101,296

(22) Filed: Dec. 9, 2013

(30) Foreign Application Priority Data
Nov. 20, 2013 (KR) 10-2013-0141650

(51) Int. Cl. B01F 13/06

(52) U.S. Cl. CPC B01F 13/065
USPC 366/139

(57) ABSTRACT

Disclosed is a dental vacuum mixer which includes: a body comprising a magnet sensor, a mixing motor and a control means; a mixing unit coupler through which a driving shaft of the mixing motor passes to be combined; and a mixing unit composed of a mixing container, a cover combined with the mixing container, and a magnet installed at the position corresponding to the magnet sensor on the upper side of the cover.

### CROSS-REFERENCE TO RELATED APPLICATIONS

This application claims priority to and the benefit of Korean Patent Application No. 10-2013-0141650 filed in the Korean Intellectual Property Office on Nov. 20, 2013, the entire contents of which are incorporated herein by reference.

### TECHNICAL FIELD

The present invention relates to a dental vacuum mixer. More specifically, it relates to a vacuum mixer of which the efficiency of vacuum suction is improved and which is more user-friendly by detecting combination of a body with a mixing container by means of a magnet sensor to control mixer operation.

### BACKGROUND

In general, dental laboratory technicians use impression material, for example, alginate, to produce dental prostheses in the steps of taking a tooth impression with the impression materials; pouring plaster into the impression to make a plaster cast; fabricating a wax model; and molding a prosthesis out of a dental investment.

The impression materials or the plaster used in the aforementioned process feature fast curing when it is mixed with water. Therefore, dental technicians do not mix the impression material or the plaster powder with water in advance, but mix it with water just before taking a tooth impression or making a plaster cast to form dough thereof.

By the way, if air is introduced and mixed in the process of mixing the impression material or the plaster powder with water, the dough has bubbles therein, and the surface of the plaster model or cast is thus not smooth or dense because the bubbles escape during the process of curing.

To avoid such an issue, most dental technicians use a vacuum mixer for forming dough out of the impression material or the plaster powder.

The vacuum mixer is composed of a body with a vacuum pump and a mixing motor, and a mixing unit equipped with a mixing container and a mixing blade, as disclosed in Korean Patent No. KR10-0460611. The vacuum mixer rotates the mixing blade to mix the materials therein while it sucks and exhausts air in the mixing container, with the body being combined with the mixing unit in the manner of vacuum suction.

An automatic vacuum mixer is currently available in the market, which automatically starts operation when the mixing unit is combined with the body although the operation switch is not manually operated.

A conventional automatic vacuum mixer 10 illustrated in FIG. 1 includes a body 20 and a mixing unit 30 combined with or removed from the lower part of the body. The body 20 is equipped with a mixing motor 22 and a vacuum pump 23 therein, and the lower part of the body 20 is equipped with a mixing unit coupler 26. The mixing unit 30 is combined with or removed from the mixing unit coupler 26.

A sensor rod 28 passes through the mixing unit coupler 26 to be combined therewith, and the body 20 has a photosensor 29 therein to detect the upper end of the sensor rod 28

The mixing unit 30 includes a mixing container 31, a cover 32 combined with the upper side of the mixing container 31, a mixing blade 35 installed in the mixing container 31, and a mixing shaft 36 which passes through the cover 32 and of which the lower end is combined with the mixing blade.

The upper side of the cover 32 is formed with a ring-shaped concave flow path 33 which has a vent hole 34 on the bottom thereof. The mixing unit coupler 26 is formed with a suction hole 27 which communicates with the flow path 33.

Therefore, where the mixing unit 30 is combined with the mixing unit coupler 26, the sensor rod 28 is pushed up and raised by the cover 32 of the mixing unit 30, and the photosensor 29 detects the upper end of the sensor rod 28. When the photosensor 29 detects the sensor rod 28, a controller controls the vacuum pump 23 to operate so that the air in the mixing container 31 can be exhausted through the vent hole 34 and the suction hole 27. The mixing motor 22 operates to rotate the mixing blade 35 and thus to mix the materials in the mixing container 31.

However, the conventional automatic vacuum mixer 10 has some issues described below.

First, as shown in the magnified view of FIG. 2, the mixing unit coupler 26 is formed with a through-hole 28a for installing the sensor rod 28. Therefore, the air in the body 20 can be introduced through the through-hole 28a in the process of vacuum suction to lower the efficiency of vacuum suction.

The upper side of the cover 32 of the mixing unit 30 is formed with an insertion recess 39 into which the lower end of the sensor rod 28 is inserted, and a sealing member made out of exemplary silicone can be installed around the insertion recess 39 to address the aforementioned issue. However, the sealing member can be deteriorated in terms of sealing efficiency if it is used for a long period of time.

Second, positional alignment is required in order to insert the lower end of the sensor rod 28 into the insertion recess 39 formed in the cover 32 to combine the mixing unit 30 with the body 20. It is not a user-friendly process.

If the insertion recess 39 is not formed in the cover 32, positional alignment is not required and it is thus more user-friendly. However, it is still not easy to avoid the air being introduced through the through-hole 28a.

### SUMMARY

The present invention has been made in an effort to address the aforementioned issues. It is an object of the present invention to provide an automatic dental vacuum mixer which avoids the efficiency of vacuum suction being lowered, and does not need accurate positional alignment to combine the mixing unit with the body and thus to be more user-friendly.

To achieve the aforementioned object of the present invention, the dental vacuum mixer according to the present invention includes a body comprising a magnet sensor, and a control means for controlling the operation of the mixing motor and the vacuum pump by using the signal of the magnet sensor;

A mixing unit coupler combined with open lower part of the body, through which the driving shaft of the mixing motor passes to be combined and which is formed with a suction hole to be connected with the vacuum pump; and

A mixing unit combined with or removed from the mixing unit coupler, and composed of a mixing container, a cover combined with the upper end of the mixing container and formed with a vent hole, a mixing shaft which passes through the cover, a mixing blade combined with the mixing shaft in the mixing container, and a magnet installed at the position corresponding to the magnet sensor on the upper side of the cover.

The dental vacuum mixer according to the present invention is characterized in that the magnet of the mixing unit is a ring-shaped magnet which surrounds the mixing shaft.

The dental vacuum mixer according to the present invention is characterized in that a plurality of the magnets are installed along the circumferential direction centered at the mixing shaft of the mixing unit.

The dental vacuum mixer according to the present invention is characterized in that the cover of the mixing unit is formed with a shaft fixing unit which protrudes upward for supporting the mixing shaft, and the magnet is installed in the upper end of the shaft fixing unit.

The dental vacuum mixer according to the present invention is characterized in that the upper side of the cover of the mixing unit is formed with a flow path centered at the mixing shaft, the vent hole is formed on the bottom of the flow path, and the shaft fixing unit protrudes upward to form the inner wall of the flow path.

### Effect of the Invention

According to the present invention, the magnet sensor installed in the body recognizes the magnet installed in the mixing unit to decide whether the mixing unit is combined or not. Therefore, the lowered efficiency of vacuum suction due to the through-hole formed in the mixing unit coupler is avoided.

Since the magnet sensor naturally recognizes the magnet in the process of combining the mixing shaft with the driving shaft, it is not needed to examine the position of the sensor to be more user-friendly in combining the mixing unit.

The foregoing summary is illustrative only and is not intended to be in any way limiting the present invention. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a sectional view of an exemplary conventional dental vacuum mixer;

FIG. 2 is a magnified view of A shown in FIG. 1;

FIG. 3 is a perspective view of a dental vacuum mixer according to one embodiment of the present invention;

FIG. 4 is a perspective view of the state in which the mixing unit shown in FIG. 3 is disconnected;

FIG. 5 is a sectional view of a dental vacuum mixer according to one embodiment of the present invention;

FIG. 6 is a bottom view of the body;

FIG. 7 is a perspective view of the mixing unit;

FIG. 8 is a magnified view of B shown in FIG. 5; and

FIG. 9 illustrates a flow path formed in the mixing unit coupler.

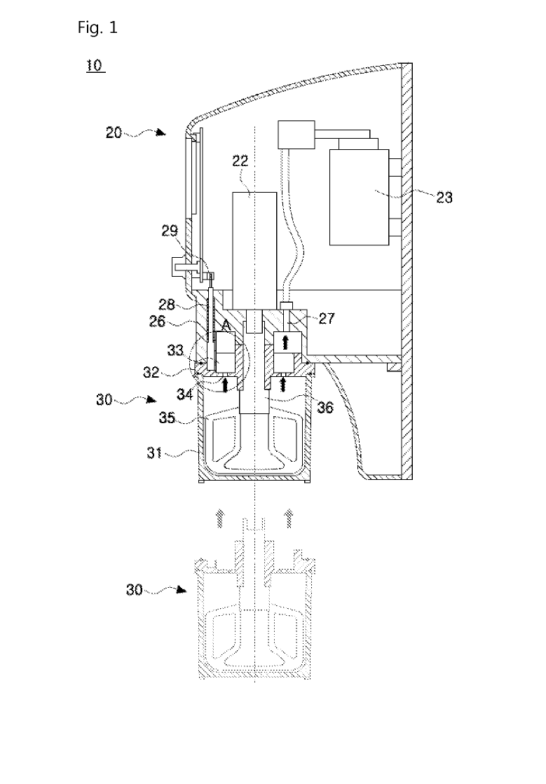

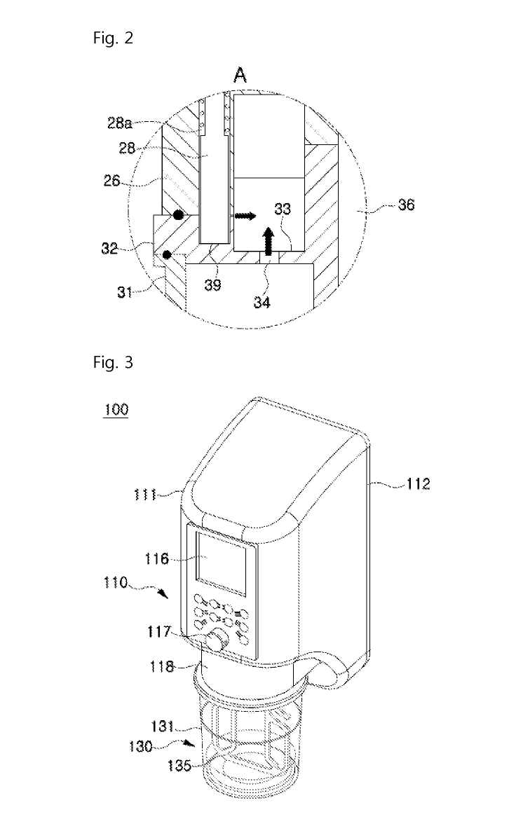

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Hereinafter, exemplary embodiments of the present invention will be described in detail with reference to the accompanying drawings.

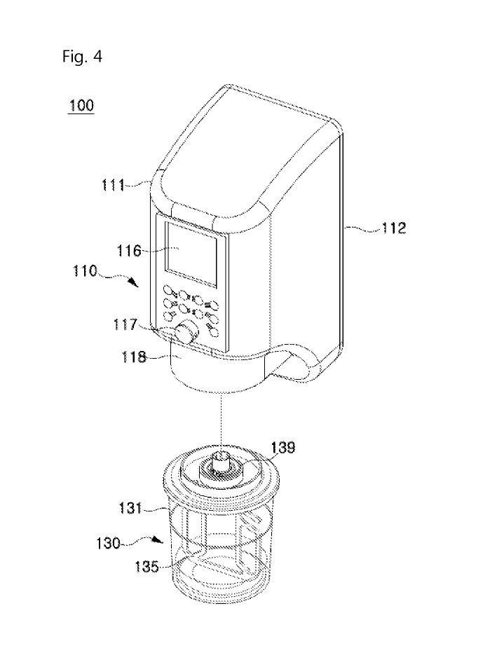

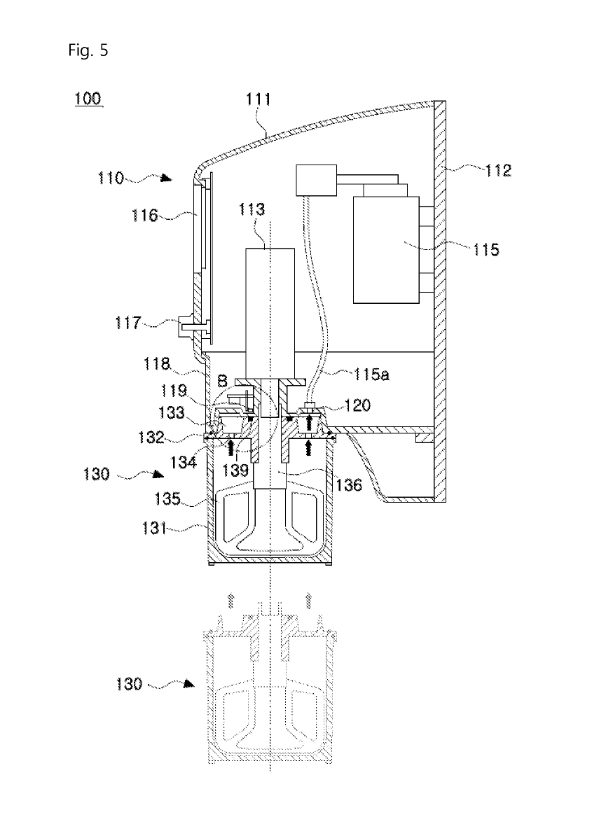

As shown in the perspective view in FIG. 3, the exploded perspective view in FIG. 4, and the sectional view in FIG. 5, the dental vacuum mixer 100 according to one embodiment of the present invention includes a body 110 and a mixing unit 130 combined with the lower end of the body 110.

The body 110 includes a mixing motor 113 equipped in the case 111, a vacuum pump 115, a PCB board installed with MyCom for control, a display 116 and a knob 117 installed on the front side of the case 111. The display 116 displays operation status of the vacuum mixer 100, and information of settings. The knob 117 is used to set up rotation speed, vacuum pressure and operation time.

A mixing unit coupler 118 is installed at the lower end of the body 110 for combining or removing the mixing unit 130. The mixing unit coupler 118 seals the open lower part of the case 111.

The body 110 is installed so that the base 112 at the back of the case 111 is hung on or fixed to a wall to make the mixing unit coupler 118 face downward.

The mixing unit coupler 118 is formed with a suction hole 120 of which the one end communicates with the ring-shaped flow path 133 formed on the upper side of the mixing unit 130, and the other end is connected with an exhaust hose 115a in the body 110.

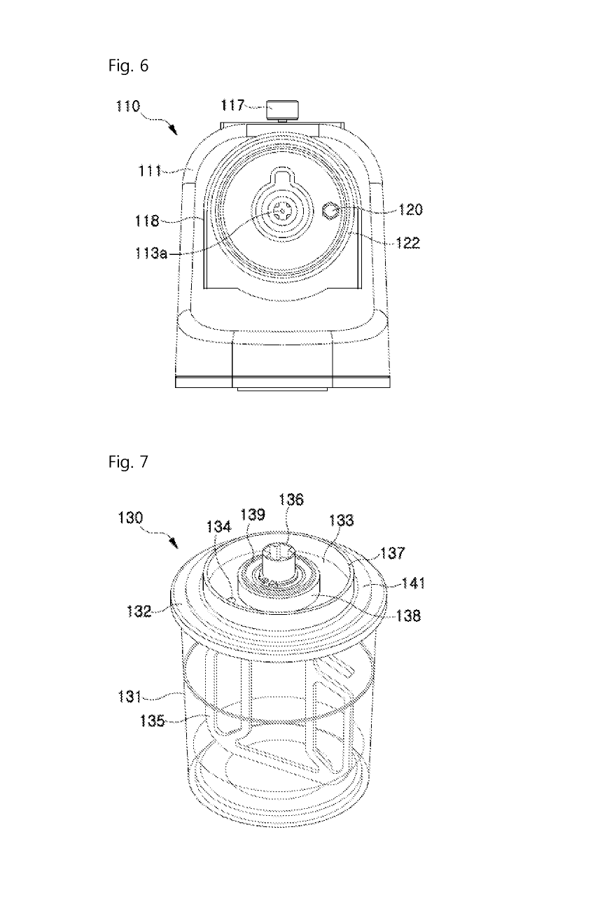

As shown in FIG. 6, the driving shaft 113a of the mixing motor 113 passes through the mixing unit coupler 118 to protrude downward. The mixing motor 113 is fixed to the mixing unit coupler 118 in the body 110. The mixing unit coupler 118 includes an outer wall 122 which surrounds both the driving shaft 113a and the suction hole 120. While the mixing unit 130 is combined, the lower end of the outer wall 122 closely stuck on the upper side of the mixing unit 130.

As shown in FIG. 7, the mixing unit 130 includes a mixing container 131 for putting materials therein and a cover 132 combined with the upper end of the mixing container 131. A mixing shaft 136 is rotatably installed through the cover 132. The mixing container 131 is combined with the cover 132 with an O-ring therebetween. A mixing blade 135 is combined with the mixing shaft 136 in the mixing container 131.

A flow path 133 concave in the circumferential direction centered at the mixing shaft 136 is formed on the upper side of the cover 132. The bottom of the flow path 133 has at least one vent hole 134. The flow path 133 is formed at the position which communicates with the suction hole 120 of the mixing unit coupler 118 to create vacuum pressure by vacuum suction. Such a flow path 133 is preferably ring-shaped, but is not necessarily limited to the ring shape.

The flow path 133 is formed between the outer wall 137 and the inner shaft fixing unit 138. The internal space of the flow path 133 communicates with the inside of the mixing container 131 through the vent hole 134. The shaft fixing unit 138 supports the mixing shaft 136 and its surrounding bearings (not shown in the Figure) and protrudes upwards to form the inner wall of the flow path 133.

An O-ring 141 is seated on the upper side of the cover 132 and located on the outside of the outer wall 137. The O-ring 141 is seated on the side which contacts the mixing unit coupler 118 for sealing to prevent the outside air from being introduced by vacuum suction.

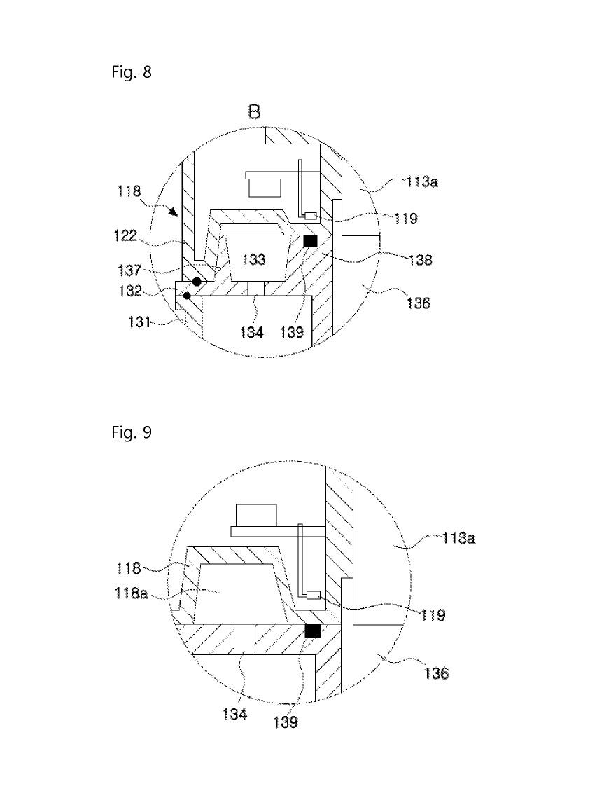

As shown in the partially magnified view of FIG. 8, the mixing unit 130 is combined with the mixing unit coupler 118 to insert the outer wall 137 of the mixing unit 130 into the inner side of the outer wall 122 of the mixing unit coupler 118.

In this case, the O-ring 141 is seated on the contact where the lower end of the outer wall 122 of the mixing unit coupler 118 contacts the cover 132 of the mixing unit 130.

In particular, in the embodiment of the present invention, a magnet 139 is mounted on the upper end of the shaft fixing unit 138. The magnet 139 is preferably installed along the circumferential direction centered at the mixing shaft 136. Although it is preferred to use a ring-shaped magnet 139 arranged at the same axis as the mixing shaft 136, a plurality of magnets 139 can be arranged in the circumferential direction.

A magnet sensor 119 corresponding to the magnet 139 of the mixing unit 130 is installed in the body 110. As shown in FIG. 8, the magnet sensor 119 is preferably to be positioned on the side directly facing the magnet 139 while the mixing unit 130 is combined with the body 110. By the way, the mixing unit coupler 118 is positioned between the magnet sensor 119 and the magnet 139.

Since the magnet 139 is installed on the upper end of the shaft fixing unit 138 which surrounds the mixing shaft 136, it is essential to install the magnet sensor 119 to be close to the driving shaft 113a of the mixing motor.

When the mixing unit 130 is raised to combine the mixing shaft 136 with the driving shaft 113a of the mixing unit coupler 118, the magnet sensor 119 detects the magnet to create a given electrical signal.

For example, when the Mi-Com (controller) of the vacuum mixer 100 receives a signal from the magnet sensor 119, it operates the vacuum pump 115. Since vacuum pressure is created in the flow path 133 on the upper side of the mixing unit 130 when the vacuum pump 115 operates, the mixing unit 130 is closely attached to and is not removed from the lower side of the mixing unit coupler 118.

When the Mi-Com (controller) operates the mixing motor 113, the mixing shaft 136 combined with the driving shaft 113a rotates, so that the materials are mixed in the mixing container 131. In this process, since the vacuum pump 115 continues to operate, the air in the mixing container 131 continues to be exhausted through the vent hole 134 to minimize the amount of air introduced into and mixed with the materials.

Meanwhile, the driving shaft 113a exposed toward the lower part of the mixing unit coupler 118 should be combined with the mixing shaft 136 of the mixing unit 130 in order to equip the body 110 with the mixing unit 130.

As in the embodiment of the present invention, where the magnet 139 is installed on the upper end of the shaft fixing unit 138 close to the mixing shaft 136, the magnet sensor 119 naturally recognizes the magnet 139 in the process of combining the mixing shaft 136 with the driving shaft 113a. One thing needed is just to combine the mixing shaft 136 with the driving shaft 113a, and there is no need to consider the positions of the magnet sensor 119 and the magnet 139 to combine the mixing unit 130. Therefore, the dental vacuum mixer according to the present invention is more user-friendly in comparison with conventional vacuum mixers which use a sensor rod.

Since there is also no need to form a through-hole to install a sensor rod in the mixing unit coupler 118, introduction of outside air and the lowered efficiency of vacuum suction resulting from the through-hole is avoided.

Although the preferred embodiment of the present invention is described above, the present invention is not limited to the embodiments described above, and can be modified or altered in various manners format.

In the exemplary embodiments of the present invention described above, although the flow path 133 is formed on the upper side of the cover 132 of the mixing unit 130, the upper side of the cover 132 can be made flat and the flow path 118a can be formed on the lower side of the mixing unit coupler 118 to surround the driving shaft 113a, as shown in FIG. 9.

In the exemplary embodiments of the present invention described above, although the magnet 139 is installed on the upper end of the shaft fixing unit 138 positioned on the inner side of the flow path 133, the position of the installation is not necessarily limited thereto, and can be outside of the flow path 133. However, if the magnet 139 is installed on the outside of the flow path 133, the magnet sensor 119 can detect the magnet 139 while the mixing shaft 136 is not combined with the driving shaft 113a. It is thus desirable to install the magnet 139 on the shaft fixing unit 138 located on the inner side of the flow path 133.

As described above, the exemplary embodiments have been described and illustrated in the drawings and the specification. The exemplary embodiments were chosen and described in order to explain certain principles of the invention and their practical application, to thereby enable those skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the present invention which is limited only by the claims which follow.

Description of numerals in drawings

| | | |
|---|---|---|
| 100: dental vacuum mixer | 110: body | 111: case |
| 113: mixing motor | 113a: driving shaft | 115: vacuum pump |
| 115a: exhaust hose | 116: display | 117: knob |
| 118: mixing unit coupler | 119: magnet sensor | 120: suction hole |
| 122: outer wall | 130: mixing unit | 131: mixing container |
| 132: cover | 133: flow path | 134: vent hole |
| 135: mixing blade | 136: mixing shaft | 137: outer wall |
| 138: shaft fixing unit | 139: magnet | 141: O-ring |

1. A dental vacuum mixer including:
a body comprising a magnet sensor, and a control means for controlling the operation of a mixing motor and a vacuum pump by using the signal of the magnet sensor;
a mixing unit coupler combined with open lower part of the body, through which the driving shaft of the mixing motor passes to be combined and which is formed with a suction hole to be connected with the vacuum pump; and
a mixing unit combined with or removed from the mixing unit coupler, and composed of a mixing container, a cover combined with the upper end of the mixing container and formed with a vent hole, a mixing shaft which passes through the cover, a mixing blade combined with the mixing shaft in the mixing container, and a magnet installed at the position corresponding to the magnet sensor on the upper side of the cover.

2. The dental vacuum mixer in claim 1, wherein the magnet is a ring-shaped magnet which surrounds the mixing shaft.

3. The dental vacuum mixer in claim 1, wherein a plurality of the magnets are installed along the circumferential direction centered at the mixing shaft.

4. The dental vacuum mixer in claim 1, wherein the cover is formed with a shaft fixing unit which protrudes upward for supporting the mixing shaft, and the magnet is installed on the upper end of the shaft fixing unit.

5. The dental vacuum mixer in claim 4, wherein the upper side of the cover is formed with a flow path centered at the mixing shaft, the vent hole is formed on the bottom of the flow path, and the shaft fixing unit protrudes upward to form the inner wall of the flow path.

6. The dental vacuum mixer in claim 2, wherein the cover is formed with a shaft fixing unit which protrudes upward for supporting the mixing shaft, and the magnet is installed on the upper end of the shaft fixing unit.

7. The dental vacuum mixer in claim 3, wherein the cover is formed with a shaft fixing unit which protrudes upward for supporting the mixing shaft, and the magnet is installed on the upper end of the shaft fixing unit.
